(19) United States
(12) Patent Application Publication
(10) Pub. No.: US 2003/0088483 A1
(43) Pub. Date: May 8, 2003

(54) System, method and computer program product for an enhanced E-commerce graphical user interface

(75) Inventor: Mike Moyer, Seattle, WA (US)

Correspondence Address: FOLEY & LARDNER, 777 EAST WISCONSIN AVENUE, SUITE 3800, MILWAUKEE, WI, 53202-5308, US

(73) Assignee: Bissell, Inc.

(21) Appl. No.: 09/751,081

(22) Filed: Dec. 28, 2000

(51) Int. Cl. G06F 17/60

(52) U.S. Cl. 705/27; 705/26

(57) ABSTRACT

A system, method and computer program product are provided for conducting business over a network utilizing a graphical user interface. Initially, a request indicating a primary product or service is received utilizing a network. In response to the request, the primary product or service is displayed on a graphical user interface utilizing the network. Further in response to the request, at least one secondary product or service associated with the primary product or service is displayed utilizing the network. As such, a user may conveniently select the at least one secondary product or service utilizing the network. In one embodiment, the secondary products or services are intended to be used with the primary product or service.

### FIELD OF THE INVENTION

The present invention relates to graphical user interfaces, and more particularly to graphical user interfaces for selling products and/or services utilizing a network.

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to conducting electronic commerce. Many Web servers have been developed through which vendors can advertise and sell product. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming Web page to the client computer system and schedules shipment of the items.

The selection of the various items from the electronic catalogs is generally based on the “shopping cart” model. When the purchaser selects an item from the electronic catalog, the server computer system metaphorically adds that item to a shopping cart. When the purchaser is done selecting items, then all the items in the shopping cart are “checked out” (i.e., ordered) when the purchaser provides billing and shipment information. In some models, when a purchaser selects any one item, then that item is “checked out” by automatically prompting the user for the billing and shipment information. Although the shopping cart model is very flexible and intuitive, it has a downside in that it requires many interactions by the purchaser.

In particular, a shopper must navigate through a site to locate specific items. They add items to their cart by clicking on an “Add to Shopping Cart” button. Many sites display links on product pages to other complimentary products. This process can be cumbersome as the user must navigate to other product pages before they can add the complimentary product.

There is thus a need for an ordering system that will both increase average order size and decrease the shopping cart abandon rate by overcoming the prior art difficulties set forth hereinabove.

### DISCLOSURE OF THE INVENTION

A system, method and computer program product are provided for conducting business over a network utilizing a graphical user interface. Initially, a request indicating a primary product or service is received utilizing a network. In response to the request, the primary product or service is displayed on a graphical user interface utilizing the network. Further in response to the request, at least one secondary product or service associated with the primary product or service is displayed utilizing the network. As such, a user may conveniently select the at least one secondary product or service utilizing the network. In one embodiment, the secondary products or services are intended to be used with the primary product or service.

In one embodiment of the present invention, the primary product or service and any secondary product or service selected by the user may be added to a shopping cart in response to the selection of an add icon. Further, the user may be linked to a shopping cart interface in response to the selection of a shopping cart icon on the graphical user interface. Optionally, the shopping cart interface may list the primary product or service and any secondary product or service selected by the user for reviewing the primary and secondary products or services prior to purchase.

In another embodiment of the present invention, the user may be linked to a check out interface in response to the selection of a check out icon on the graphical user interface. As an option, the check out interface may list the primary product or service and any secondary product or service selected by the user for purchasing purposes.

It should be noted that the user may be permitted to select the at least one secondary product or service by selecting a check box. Further, the user may be permitted to deselect the at least one secondary product or service by selecting the check box again. As an option, the user may be linked to an additional graphical user interface featuring the secondary products or services upon the selection of an icon indicative of the secondary products or services.

Still yet, a plurality of additional primary products or services related to the primary products or services may be displayed on the graphical user interface. Also, the user may be linked to an additional graphical user interface featuring the additional primary products or services upon the selection of an icon indicative of the additional primary products or services.

The present invention thus provides a new way of shopping. Product pages for finished goods may show thumbnails of consumables and accessories. Each product may also have a corresponding checkbox. When an “Add to Shopping Cart” button is clicked, all checked items may be added to the cart at the same time. This limits the number of navigational “clicks” required to complete a transaction. As a general rule, the easier a product is to buy, the more likely the consumer is to actually complete the transaction. As such, the present invention, provides a new ordering system that both increases average order size and decreases the shopping cart abandon rate.

### BRIEF DESCRIPTION OF THE DRAWINGS

FIG. 1A illustrates an e-commerce graphical user interface for conducting business over a network, in accordance with one embodiment of the present invention;

FIG. 1B illustrates a method of use of the graphical user interface of FIG. 1A;

FIG. 1C illustrates an additional graphical user interface featuring the secondary product;

FIG. 3 illustrates a preferred software architecture for the merchant Web sites of the system;

FIG. 4 illustrates a preferred software architecture for the consumer computers of the system;

FIG. 5 illustrates data structures accessed and manipulated by shopping basket, wallet, and address book objects on the consumer computer;

FIG. 6 illustrates the steps performed in adding information (served by a merchant Web site) about a product to the shopping basket object;

FIG. 7 illustrates the steps performed in viewing product information stored within the shopping basket;

FIG. 8 illustrates the steps performed in deleting a product from the shopping basket;

FIG. 9 illustrates steps performed in viewing details about a product from the electronic shopping basket;

FIG. 10 illustrates the steps performed in viewing and manipulating payment source data in the wallet object on the consumer computer;

FIG. 11 illustrates the steps performed in viewing and manipulating shipping address data in the address book object on the consumer computer; and

FIG. 12 illustrates the steps performed in purchasing selected products from merchant Web sites of the system over a distributed network.

### DESCRIPTION OF PREFERRED EMBODIMENTS

Glossary

The following terms and acronyms are used throughout the detailed description:

Internet

A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”)

Used herein to refer generally to both (i) a distributed collection of interlinked, user-viewable hypertext documents (commonly referred to as “Web documents” or “Web pages”) that are accessible via the Internet, and (ii) the client and server software components which provide user access to such documents using standardized Internet protocols. Currently, the primary standard protocol for allowing applications to locate and acquire Web documents is HTTP (discussed below), and the Web pages are encoded using HTML (also discussed below). However, the terms “Web” and “World Wide Web” are intended to encompass future markup languages and transport protocols which may be used in place of (or in addition to) HTML and HTTP.

Client-Server

A model of interaction in a distributed system in which a program at one site sends a request to a program at another site and waits for a response. The requesting program is called the “client,” and the program which responds to the request is called the “server.” In the context of the World Wide Web, the client is a “Web browser” (or simply “browser”) which runs on a computer of a user; the program which responds to browser requests by serving Web pages is commonly referred to as a “Web server.”

TCP/IP (Transmission Control Protocol/Internet Protocol)

A standard Internet protocol (or set of protocols) which specifies how two computers exchange data over the Internet. TCP/IP handles issues such as packetization, packet addressing, handshaking and error correction. For more information on TCP/IP, see Volumes I, II and III of Corner and Stevens, Internetworking with TCP/IP, Prentice Hall, Inc., ISBNs 0-13-468505-9 (vol. I), 0-13-125527-4 (vol. II), and 0-13-474222-2 (vol. III).

HTML (HyperText Markup Language)

A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or “HTML document”) is subsequently transferred from a Web server to a browser, the codes are interpreted by the browser and used to parse and display the document. In addition to specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

Port or Port Number

(Also referred to as “socket number.”) In the context of the Internet, a numerical identifier (normally provided in conjunction with an IP address) which is used by TCP/IP to direct incoming data to a particular application. Certain ports have been reserved by the Internet Assigned Number Authority (IANA) for certain applications. For example, port 80 is reserved for HTTP, and is used on Web sites to direct incoming traffic to a Web server. (See “URL” below.)

URL (Uniform Resource Locator)

A unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

HTTP (Hypertext Transport Protocol)

The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document or file located at the specified URL.

HTTP POST

A type of HTTP message which is used to request that the Web server accept information from the Web client. This information may, for example, be in the form of a message to be posted to a newsgroup, or a database submission which is executed by a CGI script. (See “CGI” below.)

MIME (Multipurpose Internet Multimedia Extensions) Type

A file extension or attachment which specifies the type or format of the file (e.g., HTML, text, graphics, audio, etc.). MIME typing allows the Web browser to determine how to process a file that is received from a Web server. For example, a file of MIME type HTML (extension “.htm” or “.html”) will be displayed by the browser, while a file of MIME type X-WAV (extension “.wav”) will typically be passed to an audio player which can handle the Microsoft WAV format. Standard Web browsers come pre-configured to handle popular MIME types. In addition, standard Web browsers can easily be configured by the user to handle new MIME types; this typically involves specifying the file extension of each new MIME type, and specifying the path and filename of the application (referred to as a “MIME handler”) to which files of such type should be passed.

Internet Firewall

A security system placed between the Internet and an organization's network (such as a LAN) to provide a barrier against security attacks. Internet firewalls typically operate by monitoring incoming and/or outgoing traffic to/from the organization's network, and by allowing only certain types of messages to pass. For example, a firewall may be configured to allow the passage of all TCP/IP traffic addressed to port 80, and to block all other traffic. For more information of Internet Firewalls, see Chapman and Zwicky, Building Internet Firewalls, O'Reilly publishing, 1995 (ISBN 1-56592-124-0).

CGI (Common Gateway Interface)

A standard interface which specifies how a Web server (or possibly another information server) launches and interacts with external programs (such as a database search engine) in response to requests from clients. With CGI, the Web server can serve information which is stored in a format that is not readable by the client, and present such information in the form of a client-readable Web page. A CGI program (called a “CGI script”) may be invoked, for example, when a Web user fills out an on-screen form which specifies a database query. One disadvantage of CGI is that it generally requires the launching of a separate process for each client request received. For more information on CGI, see Ian S. Graham, The HTML Source Book, John Wiley and Sons, Inc., 1995 (ISBN 0471-11894-4), pp. 231-278.

ISAPI (Internet Server Application Program Interface)

Microsoft's interface for allowing a Web server (or other information server) to launch and interact with external programs in response to requests from clients. ISAPI programs are in the form of dynamic link libraries (DLLs) which run in the same process space as the Web server. Thus, ISAPI performs a similar function to that of CGI, but without requiring the launching of a separate process. Documentation on ISAPI is available from Microsoft Corporation as part of the Microsoft Internet Information Server Software Development kit.

Preferred Embodiments

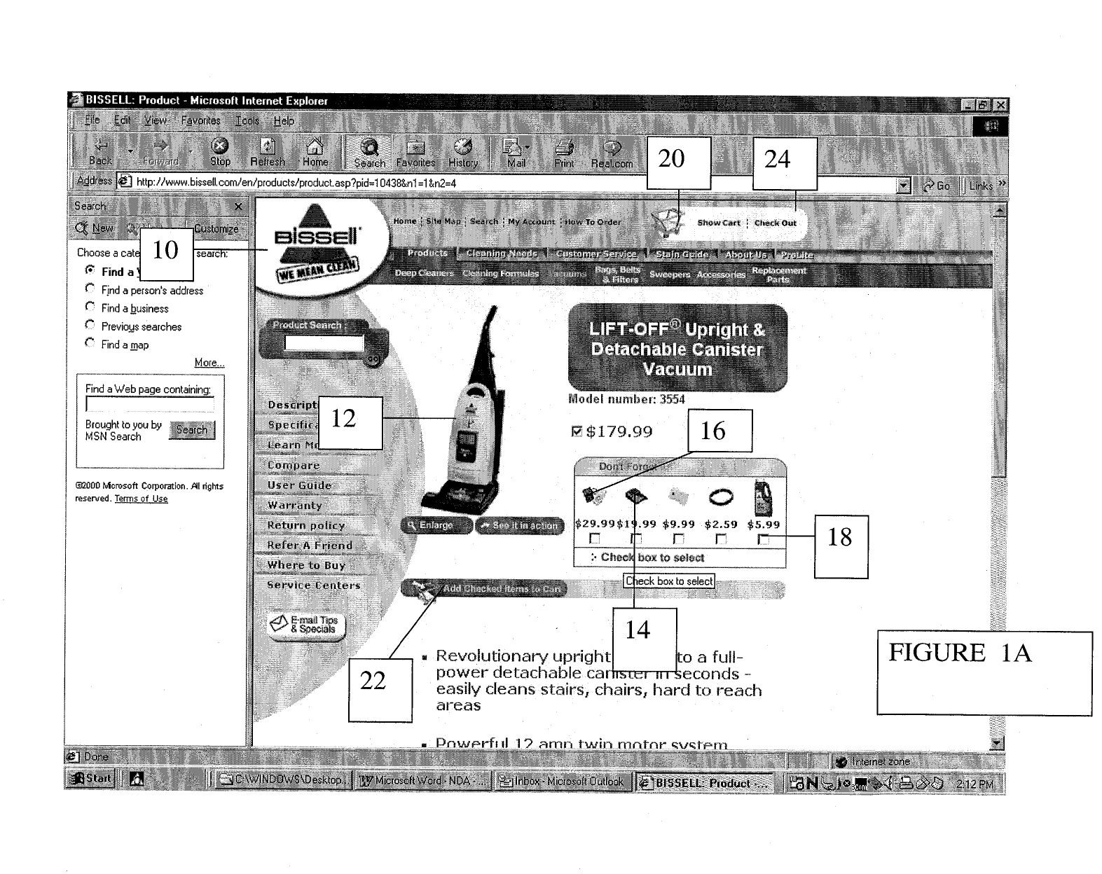

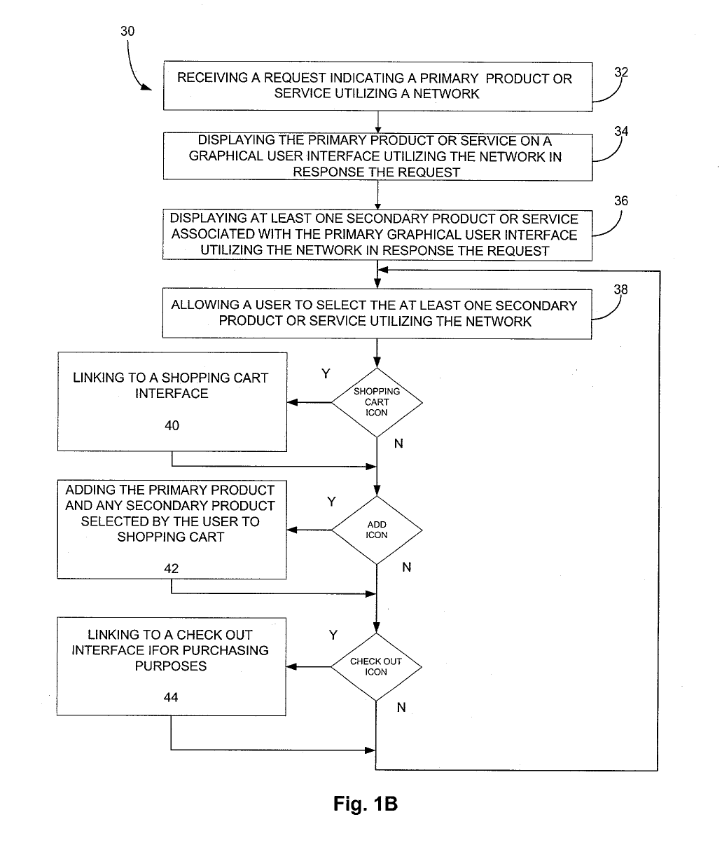

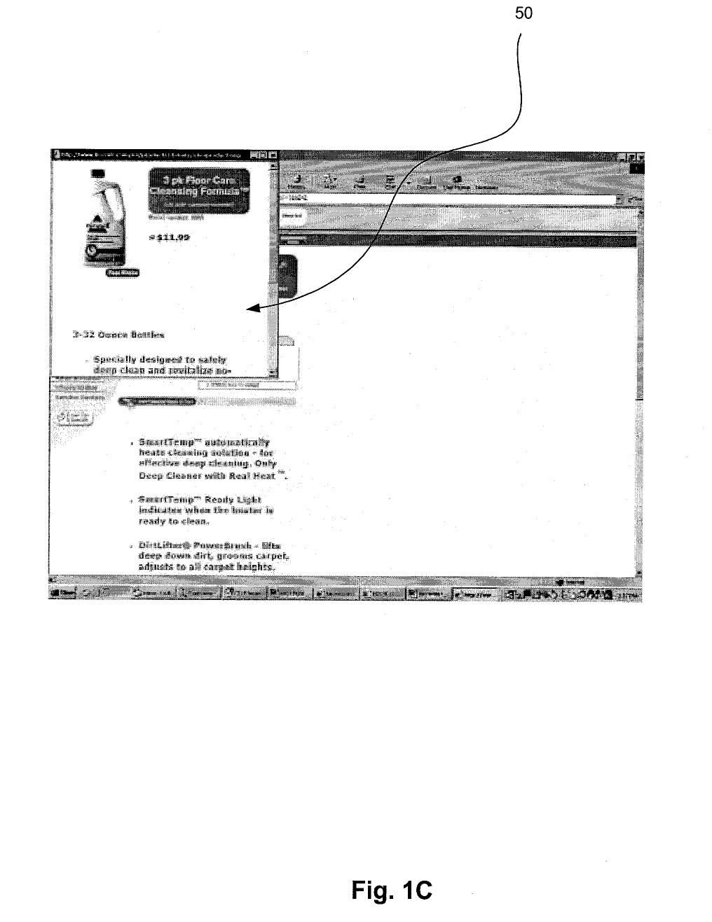

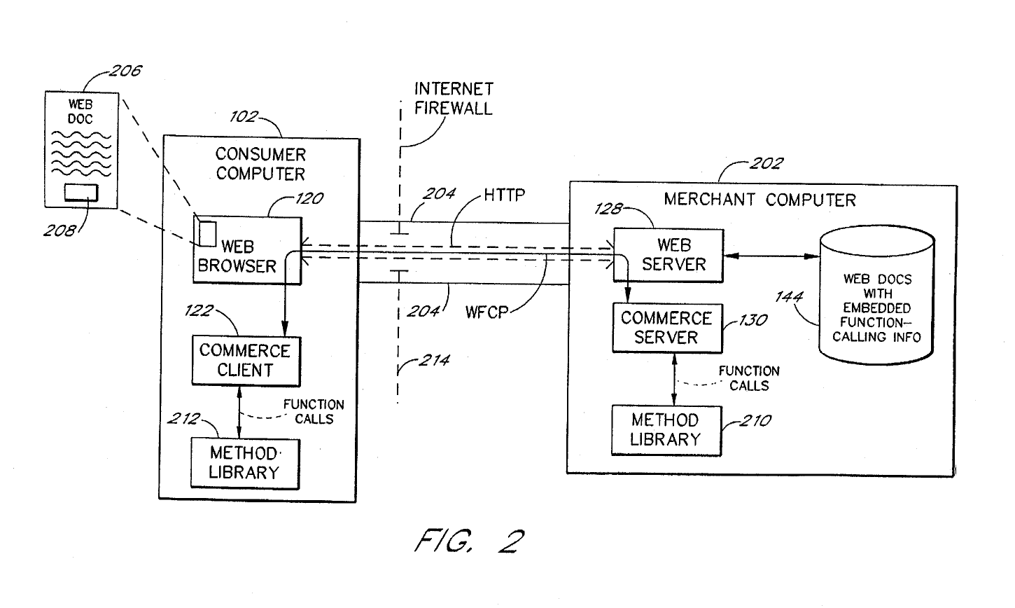

FIG. 1A illustrates an e-commerce graphical user interface 10 for conducting business over a network, in accordance with one embodiment of the present invention. As shown, a primary product 12 is shown along with a plurality of additional primary products 14 and a plurality of secondary products 16. For reasons that will soon become apparent, a plurality of check boxes 18 are positioned adjacent to the secondary products 16, as shown. With continuing reference to FIG. 1A, a shopping cart icon 20, an add icon 22, and a check out icon 24 are provided.

FIG. 1B illustrates a method 30 of use of the graphical user interface 10 of FIG. 1A. Initially, in operation 32, a request indicating a primary product is received utilizing a network. Such request may be received via a previous graphical user interface identifying the primary product 12. In one embodiment, the request may be received by a user selecting a hyperlink associated with the primary product 12. It should be noted that, in the present description, the various products may be replaced with services. Moreover, the terms products and services are deemed to cover any type of entities for sale.

In response to the request, the primary product is displayed on a graphical user interface utilizing the network, as indicated in operation 34. See FIG. 1A. Further in response to the request, at least one secondary product 16 associated with the primary product is displayed utilizing the network. Note operation 36. In one embodiment, the secondary products are intended to be used with the primary products, i.e. accessories, complementary products, etc. For example, the primary product 12 may include a vacuum cleaner, while the secondary product 16 includes cleaners or other accessories to be used with the vacuum cleaner.

As such, a user may select the at least one secondary product utilizing the network, as indicated in operation 38. It should be noted that the user may be permitted to select the at least one secondary product by selecting the associated check box 18 of FIG. 1A. Further, the user may be permitted to deselect the at least one secondary product by selecting the check box 18 again.

With continuing reference to FIG. 1B, the primary product 12 and any secondary product 16 selected by the user may be added to a shopping cart in response to the selection of the add icon 22 of the graphical user interface 10 of FIG. 1A. Note operation 42. When added to the shopping cart, the primary product 12 and any secondary product 16 are stored for being included in a purchase order to be placed later. More information regarding such process will be set forth hereinafter in greater detail.

Further, the user may be linked to a shopping cart interface in response to the selection of the shopping cart icon 20 on the graphical user interface 10. See operation 40. In one embodiment, the shopping cart interface may list the primary product and any secondary product selected by the user for reviewing the primary and secondary products prior to purchase.

Once all desired products are added to the shopping cart, the user may be linked to a check out interface in response to the selection of the check out icon 24 on the graphical user interface 10 of FIG. 1A. Note operation 44. As an option, the check out interface may list the primary product and any secondary product selected by the user for purchasing purposes.

FIG. 1C illustrates an additional graphical user interface 50 featuring the secondary product 16. Such graphical user interface 50 may be displayed upon the selection of an icon indicative of the secondary product, i.e. see 16. Such additional graphical user interface 50 is intended for providing the user with additional information about the secondary product 16.

In one embodiment, additional primary products 14 related to the primary products 14 may be displayed on the graphical user interface 10 of FIG. 1A. Also, the user may be linked to an additional graphical user interface (similar to that of FIG. 1A) featuring the additional primary products 14 upon the selection of an icon indicative of the additional primary product, i.e. see 14.

Alternate Implementations

The following sections and subsections describe one exemplary environment in which the invention may be implemented. It should be noted that the present invention may be implemented in any desired context.

Communication Between Commerce Client and Commerce Server

The present embodiment may extend the functionality of the standard Web browser 120 by adding shopping-related features, namely, a shopping basket in which product information can be gathered, a wallet in which sources of payment can be stored, and an address book in which shipping addresses can be recorded. The standard Web browser 120, so extended, offers consumers an extremely convenient and consistent method of shopping for products over the World Wide Web. This section describes a method for a Web browser to call functions on both its own local computer and also on a computer executing a Web server. Additionally, a method is described for allowing a Web server to call functions on a computer executing a Web browser.

FIG. 2 illustrates communication between a consumer computer 102 and a merchant computer 202. A consumer accesses a merchant computer 202 on the Internet 204 via a consumer computer 102. The consumer computer 102 includes a standard Web browser 120, and the merchant computer 202 includes a Web server 128. The Web browser 120 and the Web server 128 use the HTTP protocol to communicate with each other over the Internet.

The Web server 128 running on the merchant computer 202 accesses a local store 144 of HTML documents (also commonly referred to as “Web documents” or “Web pages”). When the Web browser 120 on the consumer computer 102 requests an HTML document, the Web server 128 retrieves the HTML document and transmits it to the Web browser 120 on the consumer computer 102 where it is viewed by the consumer. These documents typically include information about the merchant, as well as information about the products sold by the merchant (including pictures and descriptions of products and product prices).

To provide more sophisticated shopping transactions between consumers and merchants, software dedicated to providing consumer-oriented shopping functions (the commerce client 122) executes on a consumer's computer, and software dedicated to providing merchant-oriented functions (the commerce server 130) executes on a merchant computer 202. One objective of the present invention is to provide both a commerce client 122 running on the consumer computer 102 which communicates directly with the Web browser 120, and a commerce server 130 running on the merchant computer 202 which communicates directly with the Web server 128.

The commerce client 122 and the commerce server 130 utilize the Internet-based communication between the Web browser 120 and the Web server 128 to communicate with each other. An extensible Web function-calling protocol (“WFCP”) permits the commerce client 122 and the commerce server 130 to pass functions calls to each other by embedding the function calls in data exchanged via the Internet by the Web browser 120 and the Web server 128. As illustrated in FIG. 2, the Web function-calling protocol effectively “tunnels” function-calling information (requests and responses) through an HTTP message stream (shown in dashed lines) between the standard Web browser 120 and the Web server 128. One significant benefit of the use of HTTP is that it allows the consumer computer 102 to communicate with merchant Web sites from behind Internet firewalls 214 which permit passage of HTTP traffic.

The Web server 128 serves HTML documents which include embedded function calling information. This function calling information is embedded in a hidden form using standard HTML tags, and is provided in a predefined format (specified as part of the WFCP) that is recognized by both the commerce client 122 and the commerce server 130. Generally, the embedded function calling information corresponds to consumer-selectable options (e.g., hyperlinks or buttons) within HTML documents to allow a consumer to initiate client-to-server function calls across the Internet by selecting (with mouse or keyboard) transaction options.

FIG. 2 illustrates an HTML document 206 being displayed by the Web browser 120. The HTML document 206 includes a consumer-selectable button 208 associated with a textual description (such as “buy,” “update shopping basket,” “retrieve price information,” or “retrieve account information”) of a corresponding action to be performed. When the consumer clicks on this button, corresponding function-calling information is passed across the Internet as a standard HTTP POST message from the consumer computer 102 to the merchant computer 202.

The function calling information for making a corresponding function call typically includes the name of an object, an object interface, a method, and an argument list.

This function-calling information is provided in the HTML document along with a target URL (of the merchant Web site 104, 106) such that an HTTP POST message containing the information will be sent to the URL if the consumer clicks on the button 208.

Although the target URL in this example corresponds to the Web site that is the source of the HTML document, the target URL could be that of a different Web site.

Thus, when the consumer clicks on the button 208, the Web browser 120 generates an HTTP POST message coded using HTML and sends the HTTP POST message to the URL of the merchant Web site 104, 106. This message includes function-calling information (object, interface, method and arguments) to invoke a method (i.e., a software callable procedure or function) of a method library 212 on the merchant computer. If multiple function calls were linked to the button 208, the HTTP POST message would include the function-calling information for each such function call.

Upon receipt of the HTTP POST message, the Web server 128 parses the message, invokes the commerce server 130 (if not already executing) and passes the function-calling information to the commerce server 130. The commerce server 130 then invokes the specified object, and passes the arguments to the specified method using the specified interface; the commerce server 130 thereby makes the function call on behalf of the commerce client 122. Depending upon the method called, the function call may, for example, involve a query of and/or an update to a merchant database.

This function call will typically produce a response which must be communicated to the consumer computer 102. (In the context of electronic shopping, the response message may include, for example, price or inventory information for a particular product, or the result of a tax calculation requested by the consumer.) The response may include a function call or other information directed specifically to the commerce client 122. The Web browser 120 receives all data transmitted from the merchant computer 202 to the consumer computer 102. However, some of the data received by the Web browser 120 is further routed to the commerce client 122.

The Web server 128 transmits data to the consumer computer 102 by first packaging the data as a MIME message and then sending the MIME message across the Internet from the Web server 128 to the Web browser 120. If the response message is in the form of an HTML response to be displayed by the Web browser 120, the MIME type of the message will be HTML. If, on the other hand, the response message is directed to the commerce client 122 (such as when the response includes non-HTML product information), the response message will be tagged with a MIME type which corresponds to the commerce client 122, causing the Web browser 120 to forward the message to the commerce client 122.

In the preferred embodiment, the MIME type associated with the commerce client is “x-ishopper.” The message generated on the server side may include information to call a function on the consumer computer 102, in which case the MIME message will include function-calling information. This server-to-client function-calling information specifies the object, method, interface, and arguments of the client-side function call and is specified within the MIME message using the same format (illustrated above) as used for client-to-server function calls.

Upon receiving a MIME message of type “x-ishopper,” the Web browser 120 strips off the MIME headers and passes the message to the commerce client 122. As described further below, the commerce client 122 acts as a MIME handler for messages of type “x-ishopper.” The commerce client 122 then invokes the method indicated in the MIME message on the consumer computer 102 in the same manner performed by the commerce server 130 on the merchant computer 202.

Thus, using HTTP POST messages and MIME messages, function calls are placed on the merchant computer 202 by the consumer computer 102 and function calls are placed on the consumer computer 102 by the merchant computer 202. Advantageously, WFCP is not tied to any specific function or set of functions. Thus, new client-side and server-side functions can be added (and embedded within HTML documents) without modification to the existing function-calling components.

A further advantage, however, is gained in providing the Web browser 120 with a method to invoke local functions on the consumer computer 102. Using the same HTTP POST message format, the Web browser 120 invokes local functions by specifying a URL address that resolves to a local port. Rather than addressing an HTTP POST message to a remote site on the Web by using a URL similar to “http://www.sporting.sub.—goods.com”, the Web browser 120 directs the HTTP POST to the local consumer computer 102 by using the URL “127.0.0.1:100” (note that “:100” specifies local port 100). This method of directing an HTTP POST message to the local computer is facilitated by the local host service of the TCP/IP protocol stack. The URL “127.0.0.1” is a local loop-back address recognized by the local host service as identifying the local machine as the recipient of the message.

A port listener process operates on the local machine 102 monitoring a designated port such as, for example, port 100. The port listener receives the HTTP POST message, parses the content, and passes function-calling data directly to the commerce client 122. Thus, local functions are invoked by selected options coded in and hosted by a Web document wherein function-calling information is associated with the selected options.

It will be appreciated by those skilled in the art that specialized client and server processes provide substantial benefits in the context of computer-based shopping. For example, a merchant can conveniently store relatively static catalog information as HTML documents, while storing relatively dynamic product information (such as price and inventory) in a separate database (not shown in FIG. 2) which is accessed by the commerce server 130. This product information may advantageously be stored and served in a format which is recognized only by the specialized commerce client 122 (as opposed to the standard Web browser 120). Because the commerce client 122 runs in conjunction with the Web browser 120, the commerce client 122 can readily store both consumer-selected HTML (catalog) data from Web pages of merchants, and the associated non-HTML product information retrieved via client-to-server function calls.

As noted above, because all information is passed via HTTP, the commerce client 122 and commerce server 130 can advantageously communicate through Internet firewalls 214 which are typically configured to permit the passage of TCP/IP messages addressed to port 80 and which, for security reasons, are configured to block communications addressed to other ports.

Although FIG. 2 depicts a single Web server 128 interacting with a single commerce server 130, it will be recognized that other system configurations are possible. For example, multiple Web servers 128 could be provided (running on the same machine or on different machines) which interact with a single, shared commerce server 130; or, multiple commerce servers 130 could be provided which interact with a single Web server 128.

Software Architecture of Merchant Web Site

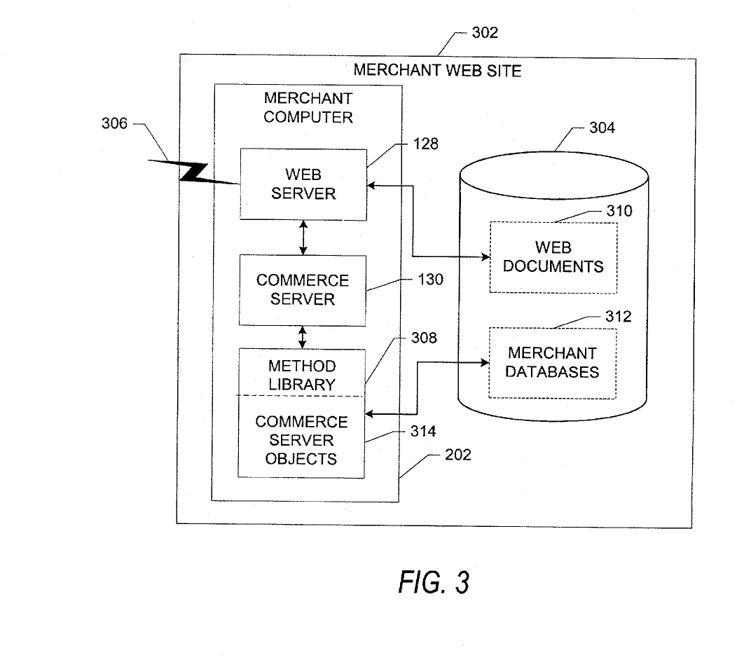

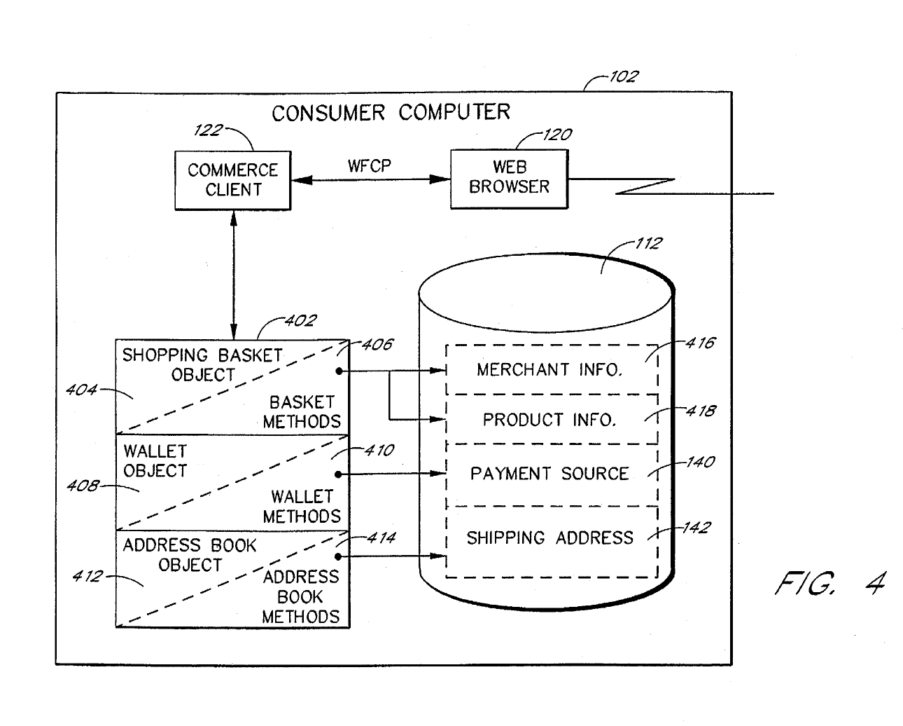

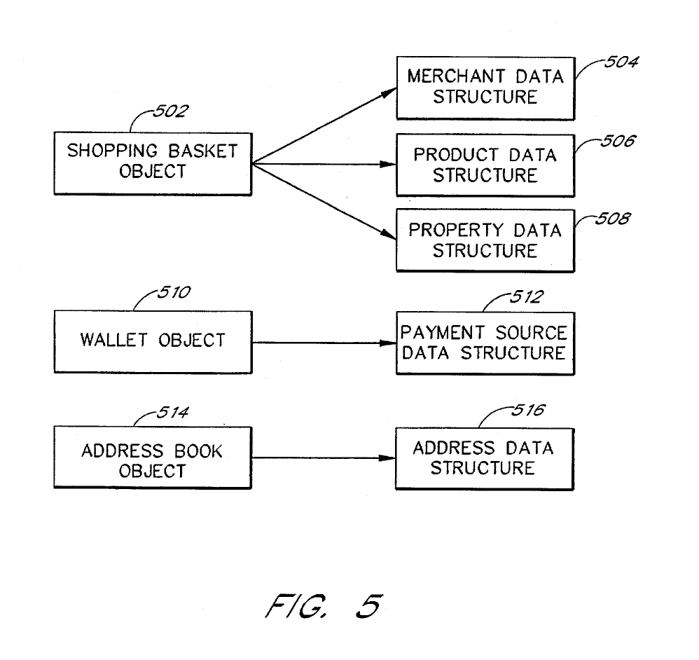

FIG. 3 illustrates a preferred architecture of a merchant Web site 302 of the computer-based shopping system. As shown in FIG. 3, the merchant Web site 302 includes a merchant computer 202, a storage device 304 (corresponding in function to the storage device 144 of FIG. 2), and an Internet connection 306. Software operating on the merchant computer 202 includes a Web server 128, the commerce server 130, and a method library 308 (corresponding to the method library 210 of FIG. 2). A collection of Web documents 310 is stored on the storage device 304 as are various merchant databases 312.

The merchant Web site 302 may, for example, be a stand-alone site which independently serves information with respect to a single merchant, or may be in the form of (or a part of) a centralized or distributed electronic mall system which serves the information of many different merchants. The Web server 128 is preferably the Microsoft Internet Information Server version 1.0, although other conventional Web servers can be used. The commerce server 130 is preferably in the form of an ISAPI (Internet Server Application Program Interface) DLL (dynamic link library) which runs within the same process space as the Web server 128. The commerce server 130 has access to commerce server objects 314 located within the same process space as the commerce server 130 and the Web server 128. A CGI script, or a DLL which uses another server extension API (such as NSAPI from Netscape), could alternatively be used.

The Web documents 310 stored on the merchant Web site 302 are preferably coded using HTML. The Web documents 310 contain HTML coding which, when received by a Web Browser 120, display various icons or buttons on the screen 114 of the consumer computer 102 along with text or pictures comprising the content of the Web document. As described above, these icons or buttons comprise selectable options which correspond to shopping-related transactions. In the preferred embodiment, the Web documents 310 offer consumers options to add product information to an electronic shopping basket, view products collected but not yet purchased, view products already purchased, enter payment information into an electronic wallet, place shipping addresses in an electronic address book, as well as order goods from Web-based merchants. These selectable options coded into the Web documents 310 have function-calling information associated with them (as described above) to invoke executable functions on the consumer computer 102 or back on the Web server 128 when selected. Web documents with embedded client-side function calls are also preferably stored on the hard disk of the consumer computer 102 as part of the user interface of the commerce client 130, allowing the user to invoke client-side functions (such as viewing the shopping basket) while offline.

The method library 308 of the merchant Web site includes methods for performing client services such as retrieval of product information, calculation of sales taxes, and capture of orders.

The commerce server 130 performs two primary tasks. First, when a request is received for product information (via function-calling information embedded within an HTTP POST message received by the Web server 128), the commerce server retrieves various data items in connection with a product, such as SKU (stock keeping unit) number, product name, product description, logo, price, expiration date, tax, and shipping charges. This data is packaged as a MIME file of type “x-ishopper” and sent back to the consumer computer 102 via the Web browser 120, as described above. Second, the commerce server 130 captures and processes orders for products submitted by consumers.

In accordance with the present invention, the merchant sites of the system prepare and serve HTML Web documents 310 which present uniform transaction options, such as View Shopping Basket, Show Wallet, and Initiate Payment.

Due to the wide variety of inventory management systems and legacy (long-existing and difficult to change) product information databases, as well as accounts receivable systems, the commerce server will often comprise custom interface software that will change from merchant to merchant. The present invention is primarily concerned with the consumer platform.

Software Architecture of Consumer Computer

FIG. 4 illustrates the software architecture of the consumer computer 102. The architecture comprises a conventional Web browser 120 (such as Microsoft's Internet Explorer 2.0, or Netscape Navigator 2.0), the commerce client 122, and a commerce client object library 402, and a storage area 112. The commerce client object library 402 comprises a shopping basket object 404 having associated shopping basket methods 406, a wallet object 408 having associated wallet methods 410, and an address book object 412 having associated address book methods 414. The storage area 112 comprises merchant information 416, product information 418, payment source data 140, and shipping address data 142, all of which has been selectively stored and/or manually entered by the user.

The Web browser 120 is preferably configured such that the commerce client 122 is a MIME-handler application. Generally, a MIME-handler is a software application designed to provide specialized processing of specific types of files received over the Internet by a Web browser 120. The Web browser 120 of the present invention is configured to associate the MIME type “x-ishopper” with a certain file name extension such as “ish.” When the Web browser 120 receives a file of type “x-ishopper,” the Web browser will cause the commerce client 122 application to begin executing (if not already running). The Web browser 120 will then pass the received “x-ishopper” file to the commerce client 122 for further processing. Extending the functionality of a Web browser by configuring the Web browser to associate specific file types with file name extensions and then associating specialized MIME-handler applications with file name extensions is well known and will not be further discussed herein.

The commerce client 122 executes on the consumer computer 102 as a separate process from the Web browser 120 and is a standard executable program. The commerce client 122 begins executing when launched by the Web browser 120 upon the Web browser's receipt of a file of MIME type “x-ishopper.” Another way in which the commerce client 122 begins executing is when a local port listener task receives a message from the Web browser 120 which was directed at a local port. The port listener launches the commerce client 122 if it is not already executing.

Still another way of launching the commerce client 122 is by running the commerce client program directly. As explained below in more detail, many functions (“local” functions) of the commerce client 122 do not require an Internet connection or transmission of data to or from a Web site. These local functions are available via user-interface HTML documents which reside on the consumer computer's hard disk. The commerce client 122 executes until the consumer selects an option causing the commerce client 122 to stop executing.

When the commerce client 122 starts running, it performs an initial task of loading structures in memory from data stored on the hard disk or other fixed storage media. The data represent merchant information, product information, payment source information, and shipping addresses. The data are stored in such a way as to be easily read into memory while maintaining relationships (links) among the data. Such construction of interlinked in-memory structures from data stored on a hard disk is well known in the art. When the commerce client 122 shuts down or otherwise terminates normally, it writes the interlinked in-memory structures to hard disk storage in a manner that preserves all the relationships among the data.

The data comprising the in-memory data structures are accessed and manipulated through objects. The shopping basket object 404 is associated with shopping basket methods 406 which read, write, modify, and display information about merchants and/or products of interest to the consumer. The shopping basket methods 406 interact primarily with in-memory structures comprising product and merchant information.

There may be a variety of properties associated with a product which are unique to that product and are not associated with other products. Such properties are represented in name/value pairs in memory and can be referenced from an in-memory product structure through an associated pointer to a linked list of such properties.

The wallet object 408 is associated with wallet methods 410 which provide access to payment source data (such as credit card numbers and checking account numbers) used for making on-line purchases.

The address book object 412 is associated with address book methods 414 which access address information for shipping purposes.

The shopping basket object 404, wallet object 408, and address book object 412 are preferably implemented as in-process COM (component object model) compliant objects, implemented as a single DLL (dynamic link library). The component object model is well-understood in the art and will not be further discussed. One skilled in the art will, however, appreciate that callable functions with appropriate associated data structures could be used in place of the shopping basket object 404, the wallet object 408, and the address book object 412 and their respective associated methods 406, 410, 414.

FIG. 5 illustrates generally the type of data accessed by the primary objects of the commerce client. A shopping basket object 502 accesses and manipulates merchant data structures 504, product data structures 506, and product property data structures 508. A wallet object 510 accesses and manipulates payment source data structures 512. An address book object 514 accesses and manipulates address book data structures 516.

As described above, the commerce client 120 responds to various function-calling information embedded in MIME files of type “x-ishopper” passed from the Web Server 128 through the Web browser 120, and also responds to function-calling information received indirectly from the Web browser 120 by way of a local port to which the Web browser directs data meant for the commerce client 122. The function-calling information identifies objects and methods which the commerce client 122 invokes.

When viewing a Web document 310 which, for example, describes a product (hosts an item) and which is coded according to the present invention, the standard Web browser displays an ADD ITEM-type option to the consumer which allows information about a product to be stored in the electronic shopping basket (in computer memory, and eventually written to a hard disk). The ADD ITEM option can be selected, for example, when the consumer has interest in the product, even if the consumer has not yet decided to purchase the product. The Web document 310 will also typically include a product form which is displayed on the consumer's computer screen. The product form represents a number of attributes which can be set by the consumer by filling in values. After setting attributes as desired (e.g., selecting a size or color for the product), the consumer selects the ADD ITEM option to store such “user preference” attributes along with the information provided by the merchant.

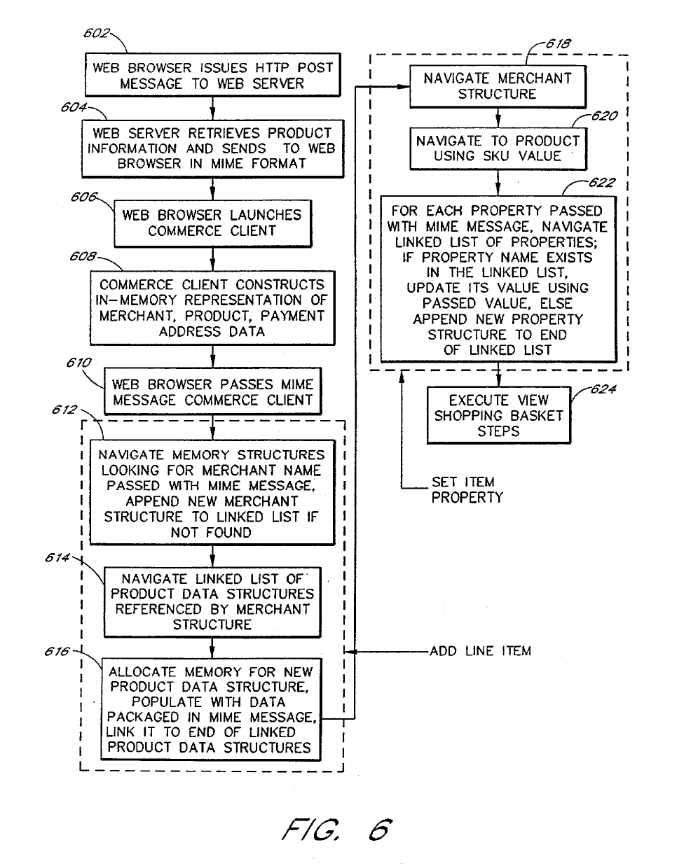

FIG. 6 illustrates the steps performed when a consumer selects the ADD ITEM option. In a first step 602 the Web browser 120 issues an HTTP POST message to the Web server 128 indicating that a consumer has selected an ADD ITEM option. In a next step 604, the Web server 128 retrieves product information from the merchant web site and sends the information to the Web browser 120 as a MIME message of type “x-ishopper.” Next, in a step 606, the Web browser 120, after establishing receipt of a MIME message of type x-ishopper, launches the commerce client 122 (if it is not already running). The commerce client, in a step 608, constructs an in-memory representation of merchant, product, payment, and address data read from a hard disk. Then, in a step 610, the Web browser 120 passes the MIME message to the commerce client 122.

The commerce client 122 uses function-calling information embedded in the passed MIME message to call a method AddLineItem. In the step 612, the AddLineItem method navigates memory structures (constructed in step 608) looking for a merchant data structure with a name field matching the merchant name passed with the MIME message. If no such merchant structure is found in the step 612, then a new merchant structure is appended to the linked list of merchants by allocating memory and the new merchant structure is populated with merchant data from the passed MIME message. The AddLineItem method then, in a next step 614, navigates a linked list of product data structures associated with the merchant structure (either found or created in the step 612). Each product data structure in the list represents one product offered for sale by a merchant. In the step 616, the AddLineItem method allocates memory for a new product data structure and populates it with data packaged in the MIME message such as product SKU, price, quantity, description, name, logo, color, or size. The AddLineItem method then links the new product data structure to the end of the linked product data structures for the merchant.

In a step 618, the commerce client 122 invokes a SetItemProperty method wherein the linked list of merchant structures is again navigated until a merchant structure having a merchant name matching the passed merchant name is found. In a step 620, the product data structures referenced by the merchant structure are navigated until a product data structure is found having an SKU field equivalent to the SKU number passed in the MIME message. Then, in the step 622, the SetItemProperty method navigates a linked list of properties referenced by the product data structure found, and does so for each property passed in the MIME message. When a property structure is found whose name matches the passed property name, the value associated with the matched property name is replaced with a value passed in connection with the property name. In each case where the property list is navigated and no matching property name is found, the SetItemProperty method appends a new property data structure to the linked list of properties. The SetItemProperty method allocates memory for the new property data structure and fills in the name and value and flag fields as appropriate from the data in the passed MIME message.

In a step 624, the commerce client 122 then executes the steps comprising the VIEW SHOPPING BASKET option described below. Thus, when the steps comprising the ADD ITEM option are completed, a new product data structure is stored in memory comprising data fields such as SKU, price, quantity, picture, description, reference URL, and merchant information. Also, any special properties associated with the product such as size, color, or finish, are also stored with the new product data structure. As explained below, default payment source information and default shipping address information are also associated with a new product data structure.

Web documents 310 served by Merchant Web sites and/or stored locally on the consumer computer 102 offer consumers a selectable option called VIEW SHOPPING BASKET. This option allows consumers to retrieve a list of all the products that have been placed inside the electronic shopping basket using the ADD ITEM option.

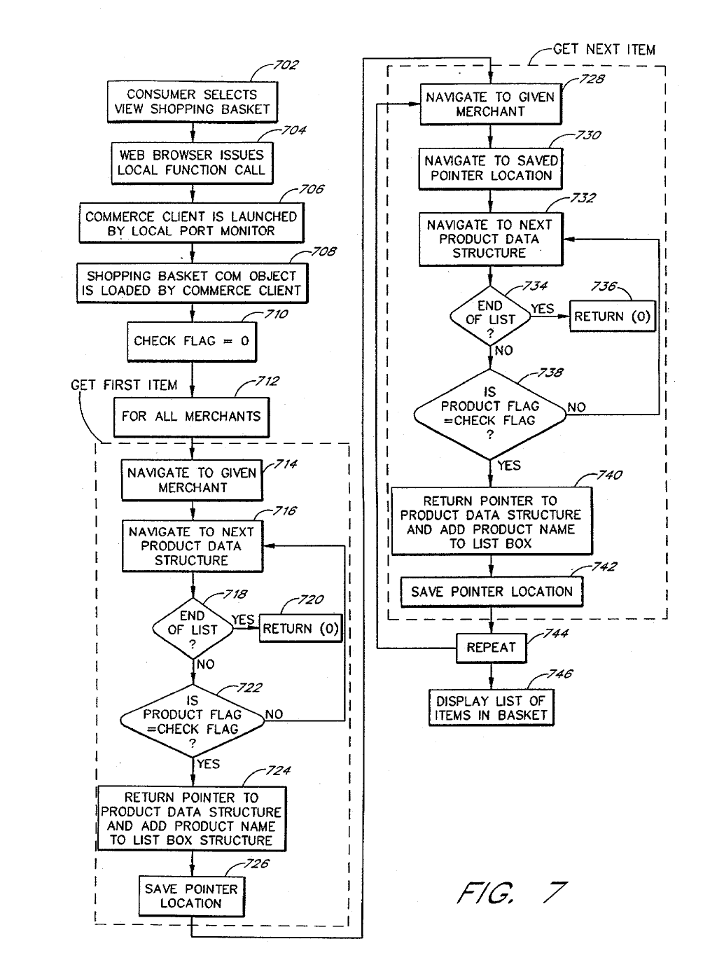

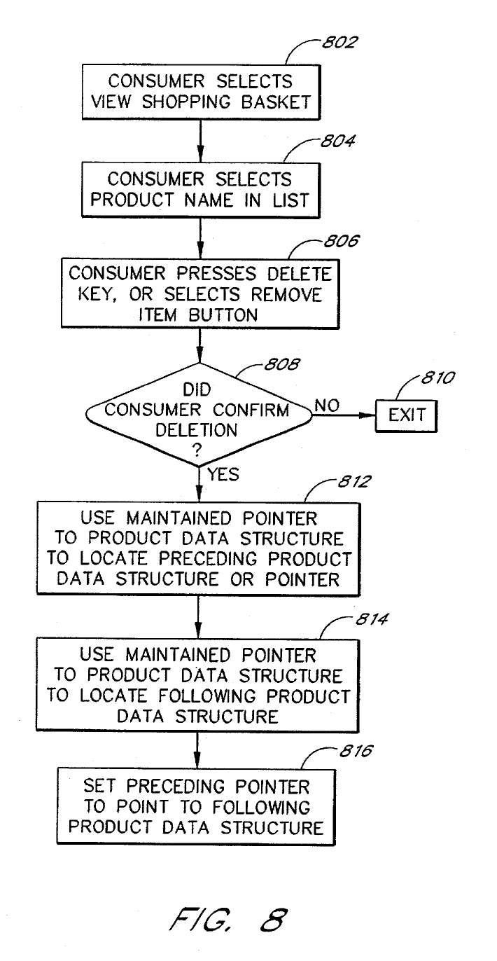

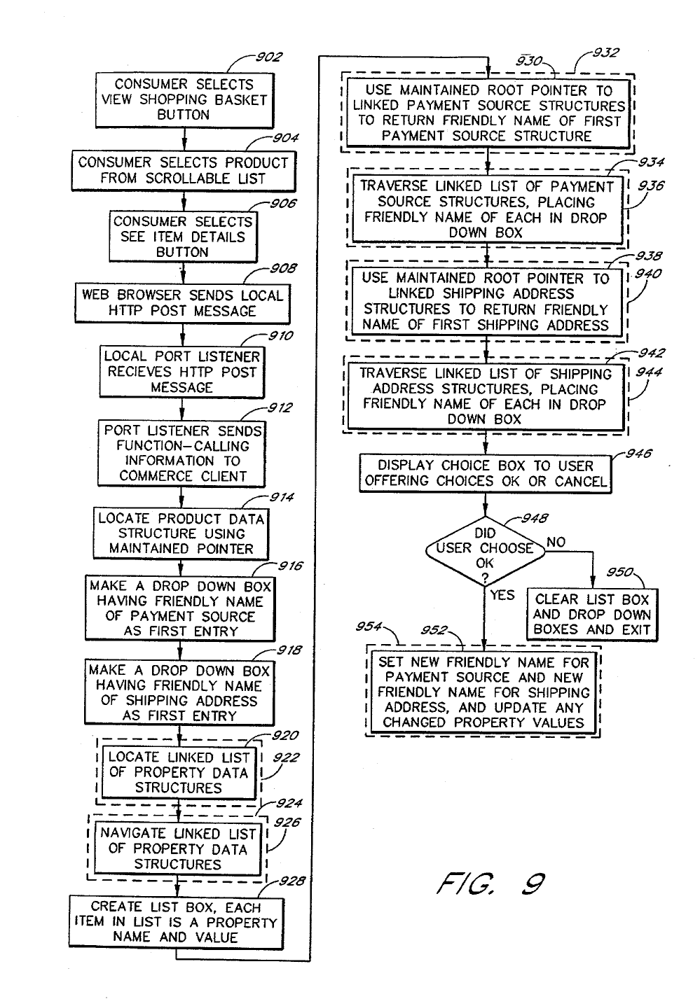

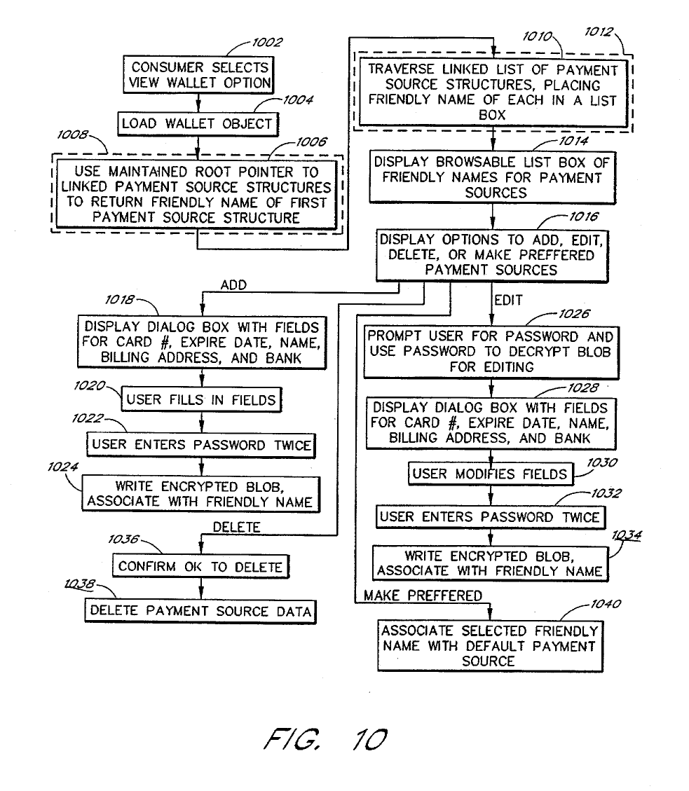

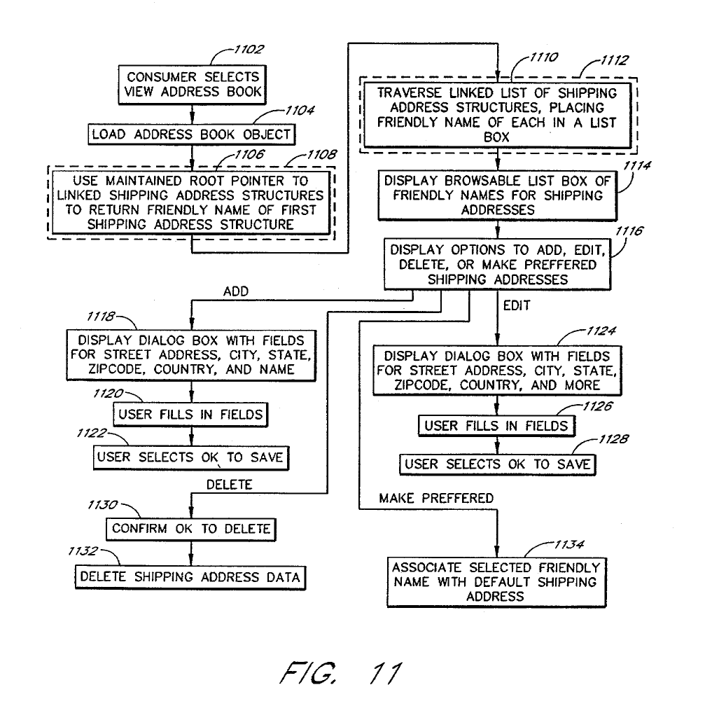

FIG. 7 illustrates the steps in carrying out the VIEW SHOPPING BASKET option. In a first step 702, the consumer selects the VIEW SHOPPING BASKET option from within the Web browser. In a next step 704, the Web browser 120 issues a local function call. Then, in a step 706, the commerce client 122 is launched (if not already executing) by a local port monitor detecting the local function call. Next, in a step 708, the commerce client 122 loads the shopping basket COM object. In a next step 710, a variable CheckFlag is set equal to 0. Then, in a step 712, a loop is entered and is executed once for each merchant data structure.

In a step 714, the commerce client 122 invokes a GetFirstItem method. In the step 714, the GetFirstItem method navigates to a given merchant. In this first iteration of the loop, the given merchant will simply be the first merchant in the merchant data structure list. In the step 716, the linked list of product data structures referenced from the first merchant data structure is navigated to the first product data structure. If, in the step 718, it is determined that there are no product data structures for this merchant or the navigation of the product data structure list has reached the end of the list, then, in a step 720, the GetFirstItem method returns a value of 0. If in the step 718 it is determined that another product data structure exists and that the end of the product data structure list has not yet been reached, then the flag field of the product data structure is compared against the CheckFlag variable. Because CheckFlag is equal to 0, the product flag is being compared against the value 0 which would indicate that the product has not yet been purchased. If in the step 722, it is determined that the product flag is not equal to the CheckFlag then processing reverts back to the step 716 to check the next product data structure in the list. If, however, in the step 722, the product flag is equal to the CheckFlag, indicating that the product has not yet been purchased, then in a step 724, a pointer is returned pointing to the product data structure of the product that has not been purchased and the name of the product that has not been purchased is added to a list box structure. Next, in a step 726 the pointer to the product data structure is saved and iterations of the loop are terminated.

In the step 728, the GetNextItem method is invoked which begins by navigating to a given merchant. In the step 730, a current chain of linked product data structures is navigated to a point equal to a saved pointer location (the pointer location saved in step 726 if this invocation of GetNextItem immediately follows the termination of the GetFirstItem method, otherwise the pointer location saved in the step 742 is used). Next, in the step 732, the next product data structure in the linked list is examined. If in the step 734 it is determined that the end of the product data structure list has been reached then in the step 736, a 0 is returned. If, however, in the step 734 it is determined that the end of the product data structure list has not yet been reached then, in the step 738, the product flag is compared against the CheckFlag. If in the step 738 the product flag is not equal to the CheckFlag then processing resumes in the step 732 examining the next product data structure in the list. If however, in the step 738 the product flat is equal to the CheckFlag then, in the step 740, a pointer is returned to the product data structure and the name of the product is added to the list box structure. Next, in the step 742, a pointer to the product data structure is saved. The GetNextItem method is then invoked again beginning at step 728 where the list of merchant data structures is navigated to the current merchant and the steps 728 through 742 are repeated until the end of the merchant data structure is reached.

When, in a step 744, the end of the merchant data structure list is reached, then in a step 746 a scrollable list of product names appears on the consumer's computer screen. The list of product names corresponds to all products currently in the electronic shopping basket which have not yet been purchased.

Web documents 310 also offer consumers a VIEW HISTORY option. By selecting VIEW HISTORY, a list of product names is displayed on the user computer, all of which have been purchased. In one embodiment, the steps illustrated in FIG. 7 in relation to the VIEW SHOPPING BASKET option are all performed in relation to the VIEW HISTORY option with one exception. In performing the VIEW HISTORY option, the CheckFlag variable in the step 710 is set equal to 1 instead of 0. Thus modified, the steps detect all product data structures whose flags are set to 1 indicating that they have already been purchased. The steps of FIG. 7 then construct a list of product names reflecting all of the products that have been purchased.

In another embodiment, selecting the VIEW HISTORY option causes a list of all product orders to be displayed. Each merchant structure has a reference pointer to a list of order structures. Each order structure, in addition to having fields for payment, shipping, and order tracking information, also has a reference pointer to a list of product structures. Thus, the linked list of merchants is traversed. For each merchant, the respective merchant's list of order structures is traversed. One display item is generated from each order structure. Each display item shows on the screen of the user computer, the purchase date, the payment information, the shipping address, the order tracking identifier, and the products ordered. Note, the products ordered are determined by traversing the linked list of product structures associated with each order structure. The VIEW HISTORY option advantageously allows consumers to examine past purchases whether such purchases occurred very recently or many years ago.

The VIEW SHOPPING BASKET and VIEW HISTORY options do not require a connection to the Internet to operate. In addition, these functions can optionally be invoked without using the Web browser. To perform these functions without a Web browser 120, the consumer initiates execution of the commerce client 122 by, for example, using a mouse and double-clicking an icon present on a graphical user interface of the consumer computer 102 (an icon with which the commerce client 122 executable program is associated). A commerce client user interface offers consumers a selection of options which do not require a connection to the Internet. These options are noted below to distinguish them from options which require Web-based communication.

Web documents 310 of the system may also host a DELETE ITEM option to remove an item from the electronic shopping basket. FIG. 8 illustrates the steps performed to carry out the DELETE ITEM option. In a first step 802, the consumer selects the VIEW SHOPPING BASKET option and is presented with a list of products which have been gathered but which have not been purchased. The DELETE ITEM option is then presented.

In a next step, 804, the consumer selects a product name from the list. Then, in a step 806, the consumer either selects the DELETE ITEM button or presses the delete key of the keyboard. The consumer is then prompted to confirm the deletion in a step 808. If the consumer does not confirm the deletion in the step 808, then, in a step 810, the steps of FIG. 8 terminate. If, however, in the step 808, the consumer does confirm the deletion, then the DeleteLineItem method is invoked.

A next step 812 then uses a pointer to the product data structure of the selected product to locate the preceding product data structure in a linked list. Locating a preceding structure in linked list is preferably done by implementing the list as a double linked list (one whose structures point both to the next structure as well as the preceding structure). It is possible that there is no preceding product data structure, that is, that the product data structure for the selected product is the first in the list of such product data structures that is referenced by a merchant data structure. In any case, a pointer to the product data structure will be located, it will simply belong to a merchant data structure rather than to a preceding product data structure.

In a step 814, the same pointer to the product data structure of the selected product is used to locate a following product data structure (i.e., one which follows the product data structure corresponding to the selected product). It is possible that there is no following product data structure or, in other words, the product data structure of the selected product has a NULL pointer to the next product data structure.

Finally, in a step 816, the pointer located in the step 812 (i.e., the pointer which points to the product data structure of the selected product) is set to point to the product data structure which follows the product data structure of the selected product. In the case where there is no product data structure following the product data structure of the selected product, then the pointer located in the step 812 is simply set to NULL. Thus, the product data structure of the selected product is no longer referenced (is delinked) from the in-memory data structures and is effectively deleted. The DELETE ITEM option is offered to consumers via the commerce client user interface as well as on Web documents displayed by the Web browser 120.

Another option that is presented to a consumer following selection of the VIEW SHOPPING BASKET option, is an option to SEE ITEM DETAILS. The SEE ITEM DETAILS option allows a consumer to check the value of the unique properties of a product (e.g., a selected color or size) as well as the payment source to be used in connection with a purchase and also the address the product is to be shipped to if ordered.

FIG. 9 illustrates the steps performed in relation to the SEE ITEM DETAILS option. First, in a step 902, the consumer selects the VIEW SHOPPING BASKET button and is presented with a list of products. In a next step, 904, the consumer, selects a product name from the list. Then, in a step 906, the consumer selects the SEE ITEM DETAILS button.

The Web browser 120 then, in a step 908, sends a local HTTP POST message directed to a local port. A port listener responds to the message in a step 910, and forwards the message to the commerce client 122 in a step 912.

In a step 914, the commerce client 122 uses a pointer to the product data structure of the selected product (this pointer is maintained following the selection of the product in connection with the VIEW SHOPPING BASKET option) to conveniently locate the product data structure of the product selected. Next, in a step 916, a drop-down box is created having the Friendly Name of a payment source (i.e., the value associated with the PaymentFriendlyName field of the product data structure) as the only entry. Similarly, in a step 918, a second drop-down box is created having the Friendly Name of a shipping address (i.e., the value associated with the AddressFriendlyName field of the product data structure) as the only entry.

A method GetFirstProperty 922 is then invoked and, in a step 920, the GetFirstProperty method, examining the contents of a property list pointer associated with the product data structure of the selected product, locates the first property data structure in a linked list of property data structures referenced by the product data structure.

Next, a method GetNextProperty 924 is repeatedly called in a step 926 to navigate the linked list of property data structures. In a step 928, a list box is created having an entry for each property name/property value pair encountered in navigating the linked list of property data structures.

In a step 930, a GetPaymentFirstFriendlyName method 932 is invoked to examine the root pointer to the linked payment source structures and to return the value of the Friendly Name of the first payment source structure. A Friendly Name, as discussed below, is simply a name like “Bob's Visa Card” which is conveniently used to designate a payment source. In the step 934, the GetPaymentNextFriendlyName method 936 is used to navigate the linked list of payment source structures, placing the Friendly Name of each in the drop-down box already created in the step 916.

In a next step 938, a GetAddressFirstFriendlyName method 940 is invoked to examine the root pointer to the linked shipping address structures and to return the value of the Friendly Name of the first shipping address structure. A Friendly Name, as used with respect to an address, is a name like “the office” or “Debbie's house” which is conveniently used to designate a shipping address. In the step 942, the GetAddressNextFriendlyName method 944 is used to navigate the linked list of shipping address structures, placing the Friendly Name of each in the drop-down box already created in the step 918.

Thus, a consumer can browse a list (displayed on the consumer's computer 102 screen as a scrollable list box) of all properties and their corresponding values associated with the selected product and can modify the property values if desired. Also, the consumer can select from either of the two drop-down boxes displayed on the consumer computer 102 to change the payment source to be used to purchase the product or to change the shipping address for delivery of the product if purchased.

In a step 946, a choice box is displayed to the consumer offering the choices OK or CANCEL. If, in the step 948, it is determined that the consumer selected CANCEL, then, in a step 950, the list box and the two drop-down boxes are cleared from the consumer computer and the steps of FIG. 9 terminate. If, however, in the step 948, the consumer selected OK, then, in a step 952, a SetItemProperty method 954 is invoked to replace the values of the properties modified by the consumer, as well as to replace the Friendly Name for payment source or shipping address if either was changed by the consumer. The SEE ITEM DETAILS option is present on the commerce client user interface as well as on Web documents.

To manage payment source information, the present invention also allows a consumer to view and modify the contents of an electronic wallet. A Web document hosts (provides to a consumer) the option VIEW WALLET and includes embedded function-calling information which invokes wallet-related functions. It will be understood that the Web browser 120 generates a HTTP POST message directed to the local consumer computer 102, and that a port listener process receives the message and passes it to the commerce client 122 and also launches (executes) the commerce client if necessary.

FIG. 10 illustrates the steps performed in connection with viewing and manipulating payment source data. In a first step 1002, the consumer selects the VIEW WALLET option. Next, in a step 1004, the commerce client 122, having received the function-calling information from the port listener, loads the wallet object. In a step 1006, the GetPaymentFirstFriendlyName method 1008 is invoked to examine a maintained root pointer (a pointer to the first in a linked list of payment source data structures) to determine the value of the Friendly Name associated with the first payment source data structure. This first Friendly Name is used as the first entry in a list box. Next, in a step 1010, the GetPaymentNextFriendlyName method 1012 is invoked to traverse the linked list of payment source data structures and place the Friendly Name associated with each as an entry in the list box.

In the step 1014, a browsable list box is displayed to the consumer, listing all Friendly Names assigned to payment sources. In a next step 1016, options to ADD, EDIT, DELETE payment sources are presented to the consumer, as is an option to MAKE PREFERRED (establish as the default) one of the payment sources.

If, in the step 1016, the consumer selects the ADD payment source option, then, in a step 10B18, a dialog box is displayed with blank or incomplete fields corresponding to payment source information. The fields are designed to elicit information such as credit card number, issuing bank, expiration date, name on card, Friendly Name, and billing address. The consumer can enter information corresponding to a credit card, debit card, or any other cash substitute. Then, in a step 1020, the consumer fills in the fields and, if the consumer desires to retain the entered information in the electronic wallet, the user is prompted to enter a password twice for verification in a step 1022. When the passwords are typed correctly twice, then in a step 1024, the password is used to encrypt the entered payment source data, and the encrypted data is stored in association with the Friendly Name entered by the consumer which is not encrypted. The consumer can then exit from viewing the wallet or continue with further manipulations of payment source data.

If, in the step 1016, the consumer selects EDIT payment source data, then upon selecting a Friendly Name corresponding to payment source data, the consumer, in a step 1026 is prompted to enter a password. If the password is correct, it is used to decrypt the encrypted payment source information associated with the selected Friendly Name. In a step 1028, the decrypted payment source information is presented to the consumer in a dialog box. The data are broken into fields for consumer editing.

In the step 1030, the consumer modifies the data fields. When the consumer is finished updating payment source information, the consumer, in a step 1032, is prompted to enter a password twice. This password may be different from the password entered earlier to access the payment source data. When the password is successfully entered, the updated payment source data is encrypted and stored in association with the Friendly Name (which is not encrypted) 1034. Password protection at the consumer computer 102 level is an advantage of the present invention which ensures that only one person has access to credit card numbers and other financial information.

In the step 1016, the consumer may elect to DELETE payment source data. Upon selecting from the list box of step 1014 a Friendly Name corresponding to payment source data to be deleted and also selecting the DELETE payment source option, the consumer is asked, in a step 1036, to confirm the deletion request. If the consumer confirms the deletion, then payment source data associated with the selected Friendly Name is removed from the linked list of payment source data structures 1038. It will be appreciated by those skilled in the art that a password prompt can be added to the deletion steps to protect against undesired deletions.

The step 1016 also offers the option to MAKE PREFERRED one of the payment sources. Making a payment source preferred causes its Friendly Name to be associated by default with product information that is added to the electronic shopping basket. Generally, a preferred payment source would be an often used credit card account perhaps offering a very competitive interest rate or earning for the cardholder airline frequent flyer miles whenever money is spent. If the consumer, in the step 1016, selects a Friendly Name from the list box of step 1014, and then selects MAKE PREFERRED, the Friendly Name selected becomes, in the step 1040, associated with the default payment source. One of ordinary skill will understand that a confirmation check could be added to the MAKE PREFERRED steps to avoid unintended replacements of a prior default payment source. When the consumer is finished viewing and manipulating payment source data, the user terminates the VIEW WALLET options and screen display by selecting an EXIT (or similarly labeled) button.

Very similar to the manner in which the present invention facilitates viewing and manipulating payment source data in the electronic wallet is the manner in which it permits consumers to view and manipulate shipping address data in the electronic address book. FIG. 11 illustrates the steps in viewing or manipulating address book data. In a first step 1102, the consumer selects a VIEW ADDRESS BOOK option. In a next step 1104, the commerce client 122 loads the address book object.

In a step 1106, the GetAddressFirstFriendlyName method 1108 uses a maintained root pointer (always points to the first of a linked list of shipping address data structures) to examine the first shipping address data structure and to return the associated Friendly Name. A Friendly Name for a shipping address might be, for example, “My Castle,” or “Jill's Office.” The Friendly Name associated with the first shipping address data structure is used as the first entry in a browsable list box.

Next, in a step 1110, the GetAddressNextFriendlyName method 1112, is used to traverse the linked list of shipping address data structures and to include the Friendly Name associated with each structure in the list box created in step 1106. The list box is displayed to the consumer in step 1114. A step 1116 presents options to the consumer to ADD, EDIT, DELETE shipping address data, as well as to MAKE PREFERRED a shipping address.

If, in the step 1116, the consumer elects to ADD shipping address data, then, in a step 1118, a dialog box is displayed to the consumer containing blank or incomplete fields corresponding to shipping address data such as street address, city, state, country, zip code, name, and Friendly Name. In a next step 1120, the consumer enters information into the fields. When the consumer is satisfied that the information is complete and accurate, the consumer selects the OK button in the step 1122, and the new shipping address is saved in association with the new Friendly Name entered.

As with the electronic wallet, the consumer can also elect to EDIT data in the electronic address book. Because there is not as much need for security, there is no password access to or encrypting performed on the shipping address data. One skilled in the art will understand that password-protected access could be implemented in connection with the shipping address data as specified with respect to the payment source data. If the consumer elects to EDIT shipping address data, then, after selecting a Friendly Name from the browsable list displayed in the step 1114, a dialog box is displayed in a step 1124 presenting fielded data items corresponding to the existing data associated with the selected Friendly Name. In the step 1126, the consumer modifies the existing shipping address data. When satisfied that the changes are complete, the consumer selects an OK button in a step 1128 which saves the changed shipping address information in association with the Friendly Name (which may have just been changed by the user).

If, in the step 1116, the consumer elects to DELETE shipping address data, then, after selecting a Friendly Name corresponding to a shipping address, the user is prompted in a step 1130 to confirm the delete request. If the consumer confirms the delete request in the step 1130, then in a step 1132 the shipping address data is deleted along with the Friendly Name.

If the option to MAKE PREFERRED a shipping address is selected in the step 1116, then, in a step 1134 the shipping address data associated with the selected Friendly Name is associated with the default shipping address. Thereafter, any products placed into the electronic shopping basket will acquire automatically, by default, an association with the new shipping address. One skilled in the art will appreciate that a confirmation step such as that in step 1130 with respect to deleting shipping address data could be added to safeguard against unintended modifications to the default shipping address. Note that both the VIEW WALLET and VIEW ADDRESS BOOK options are available from the commerce client user interface.

With payment source information in the electronic wallet and shipping address information in the electronic address book, the present invention enables a consumer to purchase products in the electronic shopping basket. Web documents host a READY TO BUY option.

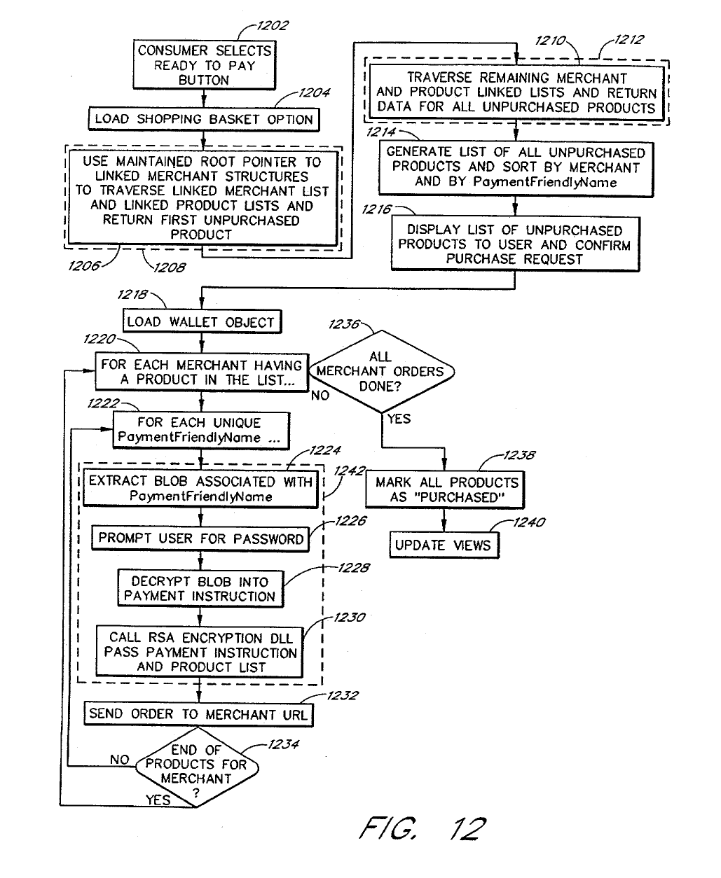

FIG. 12 illustrates the steps of purchasing a product. In a first step 1202, the consumer selects the READY TO BUY option. Next, in a step 1204, the shopping basket object is loaded. Then, in a step 1206, the GetFirstItem method 1208 is used to examine a maintained root pointer to the first merchant data structure and to then traverse and examine the linked list of product data structures associated with the first merchant and return the first located unpurchased product. The Flag of each product data structure is examined to determine if the product is already purchased. If no unpurchased products are discovered in association with the first merchant data structure, the GetFirstItem moves to the next merchant structure in the linked list of merchants. The GetFirstItem method returns information (such as a pointer) identifying the first product structure associated with an unpurchased product encountered in its traversal of the merchant and product structures.

In a next step 1210, the GetNextItem method 1212 is used to complete the traversal of the merchant and product structures, returning information identifying all product structures associated with unpurchased products. In a step 1214, a list of all unpurchased products is generated and is then sorted by merchant and by PaymentFriendlyName. Next, in a step 1216, the list of unpurchased products is displayed to the consumer, and the consumer is prompted to confirm the purchase request. If, in the step 1216, the consumer confirms the purchase, then the wallet object is loaded in a step 1218. Otherwise, the steps of FIG. 12 are terminated and no purchase occurs.

With the unpurchased product items in the electronic shopping basket sorted by merchant (e.g. “L. L. Bean”, “Bissell” or “Sears”), a step 1220 divides the product items into groups, one group per merchant. A first product group associated with a first merchant is designated for processing. A step 1222 then divides (or sorts) the first group into further subgroups according to the value of the PaymentFriendlyName (e.g., “Gold Card” or “Mary's Amex”). Thus, different orders can be submitted to one merchant, but paid for using different payment sources.

One having ordinary skill in the art will appreciate that a third subgrouping could be performed such as, for example, a subgrouping based on the value of AddressFriendlyName (e.g., “Grandma's House” or “Alaska Cabin”). Such an additional subgrouping would conveniently support orders which could be submitted to one merchant, cause payment from different payment sources and assist the merchant in shipping products to different locations. Further, products paid for from the same payment source could conveniently be shipped to different addresses.

Associating a group of products for a single merchant that are to be purchased from a single payment source, a GSO (goods and services order) is submitted to the GenerateGSOPI method 1242 on the wallet object. In a step 1224, the GenerateGSOPI method 1242 extracts the stored and encrypted data (or blob) associated with the passed PaymentFriendlyName. In a next step, 1226, the consumer is prompted for a password to authorize payment from the payment source associated with the passed PaymentFriendlyName. If the password is incorrect, the purchase is not authorized and the next subgroup of products is identified whereupon step 1222 repeats. If, however, the password is correct, then the encrypted payment source data is decrypted in a step 1228, and a payment instruction is formed from the payment source information and the product information. The payment instruction contains data sufficient to allow a merchant to complete the order. In a next step, 1230, the payment instruction along with the product list is passed to an encryption DLL to be encrypted. The encryption DLL uses RSA encryption technology (a form of public/private key encryption) which is known. The present invention is not limited by encryption technology, and other forms of encryption could be used. The GenerateGSOPI method 1242 then passes the encrypted order to a step 1232 wherein the order is sent to a merchant's order URL (held as a field associated with a product data structure) as part of an HTTP POST message. Thus, the commerce client 122 is able to bypass the Web browser and transmit HTTP POST messages itself.

After transmitting an order, the commerce client 122 then updates the in memory structure for the respective merchant. Each merchant structure includes a reference pointer to a linked list of order structures. The commerce client 122 traverses the linked list of order structures, if any, to reach the final order structure. The commerce client 122 allocates memory for a new order structure, links the new structure to the list of order structures for the merchant, and then populates the new order structure with payment information, shipping address information, and a pointer to the product structure associated with the product ordered. An order tracking identifier (“OTI”) field of the new order structure is left blank. One skilled in the art will appreciate that linked lists of structures is merely one way of associating data items together, and that other methods such as relational databases can be used to accomplish a similar association.

A merchant site receiving a product purchase order transmits an order confirmation message to a Web browser 120. The order confirmation message transmits an order tracking identifier (“OTI”) to the Web browser 120. The Web browser 120 displays the OTI on the screen of the user computer, along with a message which states, for example, “Thank you for your order. If there is any problem, please phone 1 800 123 4567 and be prepared to refer to the following order tracking identifier.” The OTI is also embedded in a MIME message of type x-ishopper which is passed by the Web browser 120 to the commerce client 122. The commerce client 122 then copies the OTI to the blank OTI field of the order structure, thus completing the storage of information related to the purchase.

A step 1234 determines whether additional products for the current merchant remain to be purchased. If so, processing resumes at the step 1222, and, if not, processing resumes upon the next group of products from the next merchant at the step 1220. A step 1236 determines whether all products for all merchants have been purchased. If not, then processing resumes with the step 1220. If all products have been purchased as determined by the step 1236, then the Flag field for every product in the electronic shopping basket is marked “purchased” (i.e., set equal to 1). Finally, in a step 1240, the steps comprising the VIEW SHOPPING BASKET option and the VIEW HISTORY option are invoked to force updates to memory structures and screen displays to avoid confusion as to whether any product was in fact purchased.

An ORDER STATUS option is presented to a user by the commerce client 122 after selection of the VIEW HISTORY option. Once a list of orders is generated and displayed to the user as described above, the user selects an order (preferably by positioning a mouse pointer over information associated with an order and clicking a mouse button). The user then selects the ORDER STATUS option. The commerce client then generates an HTTP POST message containing the order tracking identifier (“OTI”), and transmits the HTTP POST message to the order URL (uniquely identifying the Internet address of the selling merchant) associated with the product (or products) purchased. A merchant site receiving an HTTP POST message which includes an OTI determines the status of the order (e.g., “SHIPPED,” “CANCELED,” “WAITING FOR INVENTORY,” etc.). The merchant site transmits an HTML document to the Web browser which includes the status information. The Web browser of the user computer displays the status information on the screen of the user computer.

A consumer receives on-line assistance (or help) in using a computer-based shopping system by selecting a HELP option. In one embodiment, the HELP option is included in the HTML coding of a Web document and displayed to the user by a Web browser. Selecting the HELP option causes the Web browser 120 to access a HELP Web site. In another embodiment, the HELP option is displayed to the user by the user interface of the commerce client 122. Selecting the HELP option in this embodiment causes the commerce client 122 to establish a TCP/IP communication link to another computer if such a link is not already established. The commerce client 122 transmits an HTTP POST message directly to a HELP Web site. The commerce client 122 causes the Web browser 120 to begin running on the user computer if it is not already running.

In either embodiment of the HELP option, the Web browser displays help information included in documents served by a Web server of the HELP Web site. The help information, for example, describes the use of the computer-based shopping system or the cause of errors encountered in operating the computer-based shopping system, offers tips, or illustrates features of the computer-based shopping system with pictures and diagrams. One skilled in the art will appreciate that on-line help could alternatively be made available to consumers via a hierarchically ordered (topics, subtopics, and sub-subtopics) collection of information residing on the consumer computer 102.

A consumer conveniently accesses a merchant Web site 302 from which product information has been obtained by selecting the JUMP TO MERCHANT option. The user interface of the commerce client includes the JUMP TO MERCHANT option. By maintaining an association between a product name and a merchant Web site URL within the product data structure of every product, a computer-based shopping system locates a URL associated with the merchant selling a product by accessing the product data structure for the product. The commerce client 122 generates an HTTP POST message accessing the merchant Web site associated with the product. The merchant Web site responds by transmitting an HTML document to the Web browser 120. Thus, the consumer conveniently accesses the Web site from which information about a product was obtained.

A consumer terminates a computer-based shopping system by selecting an EXIT button. The EXIT button causes the commerce client 122 to write linked in-memory data structures to a hard disk (other storage devices can suffice) in a manner which preserves the link relationships. The commerce client 122 then stops executing on the consumer computer 102.

Software Description

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small-scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas: Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method for conducting business over a network utilizing a graphical user interface, comprising the steps of:
(a) receiving a request indicating a primary product or service utilizing a network;
(b) displaying the primary product or service on a graphical user interface utilizing the network in response the request;
(c) displaying at least one secondary product or service associated with the primary product or service utilizing the network in response the request; and
(d) allowing a user to select the at least one secondary product or service utilizing the network.

2. The method as recited in claim 1, and further comprising the step of linking to a shopping cart interface in response to the selection of a shopping cart icon on the graphical user interface, wherein the shopping cart interface lists the primary product or service and any secondary product or service selected by the user for reviewing the primary and secondary products or services prior to purchase.

3. The method as recited in claim 1, and further comprising the step of linking to a check out interface in response to the selection of a check out icon on the graphical user interface, wherein the check out interface lists the primary product or service and any secondary product or service selected by the user for purchasing purposes.

4. The method as recited in claim 1, and further comprising the step of adding the primary product or service and any secondary product or service selected by the user in response to the selection of an add icon.

5. The method as recited in claim 1, wherein the user to is permitted select the at least one secondary product or service by selecting a check box.

6. The method as recited in claim 5, wherein the user is permitted to deselect the at least one secondary product or service by selecting the check box again.

7. The method as recited in claim 1, further comprising the step of linking to an additional graphical user interface featuring the secondary products or services upon the selection of an icon indicative of the secondary products or services.

8. The method as recited in claim 1, further comprising the step of displaying a plurality of additional primary products or services related to the primary products or services on the graphical user interface.

9. The method as recited in claim 8, further comprising the step of linking to an additional graphical user interface featuring the additional primary products or services upon the selection of an icon indicative of the additional primary products or services.

10. The method as recited in claim 1, wherein the secondary products or services are intended to be used with the primary products or services.

11. A computer program product for conducting business over a network utilizing a graphical user interface, comprising:
(a) computer code for receiving a request indicating a primary product or service utilizing a network;
(b) computer code for displaying the primary product or service on a graphical user interface utilizing the network in response the request;
(c) computer code for displaying at least one secondary product or service associated with the primary product or service utilizing the network in response the request; and
(d) computer code for allowing a user to select the at least one secondary product or service utilizing the network.

12. The computer program product as recited in claim 11, and further comprising computer code for linking to a shopping cart interface in response to the selection of a shopping cart icon on the graphical user interface, wherein the shopping cart interface lists the primary product or service and any secondary product or service selected by the user for reviewing the primary and secondary products or services prior to purchase.

13. The computer program product as recited in claim 11, and further comprising computer code for linking to a check out interface in response to the selection of a check out icon on the graphical user interface, wherein the check out interface lists the primary product or service and any secondary product or service selected by the user for purchasing purposes.

14. The computer program product as recited in claim 11, and further comprising computer code for adding the primary product or service and any secondary product or service selected by the user in response to the selection of an add icon.

15. The computer program product as recited in claim 11, wherein the user to is permitted select the at least one secondary product or service by selecting a check box.

16. The computer program product as recited in claim 15, wherein the user is permitted to deselect the at least one secondary product or service by selecting the check box again.

17. The computer program product as recited in claim 11, further comprising computer code for linking to an additional graphical user interface featuring the secondary products or services upon the selection of an icon indicative of the secondary products or services.

18. The computer program product as recited in claim 11, further comprising computer code for displaying a plurality of additional primary products or services related to the primary products or services on the graphical user interface.

19. The computer program product as recited in claim 18, further comprising computer code for linking to an additional graphical user interface featuring the additional primary products or services upon the selection of an icon indicative of the additional primary products or services.

20. A system for conducting business over a network utilizing a graphical user interface, comprising:
(a) logic for receiving a request indicating a primary product or service utilizing a network;
(b) logic for displaying the primary product or service on a graphical user interface utilizing the network in response the request;
(c) logic for displaying at least one secondary product or service associated with the primary product or service utilizing the network in response the request; and
(d) logic for allowing a user to select the at least one secondary product or service utilizing the network.
